(19) United States
(12) Patent Application Publication
(10) Pub. No.: US 2025/0278223 A1
(43) Pub. Date: Sep. 4, 2025

(54) METHODS AND SYSTEMS FOR DETECTION OF CLOCK TAMPERING ON AN ELECTRONIC DEVICE

(71) Applicant: LEXMARK INTERNATIONAL, INC., LEXINGTON, KY (US)

(72) Inventors: STEPHEN PORTER BUSH, RICHMOND, KY (US); JENNIFER TOPMILLER WILLIAMS, LEXINGTON, KY (US); GREGORY SCOTT WOODS, LEXINGTON, KY (US)

(21) Appl. No.: 18/593,117

(22) Filed: Mar. 1, 2024

Related U.S. Application Data
(60) Provisional application No. 63/611,876, filed on Jan. 1, 0001.

(51) Int. Cl. G06F 3/12; G06F 21/44

(52) U.S. Cl. CPC G06F 3/1222; G06F 3/1238; G06F 3/1239; G06F 21/44

(57) ABSTRACT

A method of detecting clock tampering in an imaging device, comprising: reading a host start time from a host firmware clock of the imaging device, reading a security start time from a security device clock, and reading a host end time from the host firmware clock, reading a security end time, comparing a host interval time between the host start time and the host end time with a security interval time between the security start time and the security end time, and when a difference between the host interval time and the security interval time exceeds a threshold, determining that the host firmware clock has been tampered with. There is further provided an imaging device that similarly determines if the host firmware clock has been tampered with. Finally, there is provided a security device for an imaging device for determining whether the host firmware clock has been tampered with.

### CROSS REFERENCE TO RELATED APPLICATIONS

This application claims priority and benefit under 35 U.S.C. 119(e) from U.S. provisional application No. 63/611,882 titled “Methods and Systems for Detection of Clock Tampering on an Electronic Device,” having a filing date of Dec. 19, 2023.

### BACKGROUND

### 1. Technical Field

The present disclosure generally relates to methods and systems for detecting clock tampering on an electronic device, and, more particularly, methods and systems for detecting clock tampering on an imaging device.

### 2. Description of the Related Art

In electronic systems, it is often desirable to confirm the authenticity of a component of the electronic system to ensure that the entire system operates as designed. Non-authentic components employ various techniques to mimic the behavior of authentic components. This may include copying the authentic component's circuits and memory contents in order to duplicate authentication algorithms or encrypted communication between the component and the rest of the electronic system. This is particularly important in printing systems where it is desirable to confirm the authenticity of a supply component of the printing system to ensure correct operation.

It is often desirable to change the behavior of an electronic system during its lifecycle, by making changes to software or firmware. In this way, functionality and/or authentication criteria for components may be changed or added. For example, changes in imaging device functionality may include deployment of latent firmware functions (e.g., countermeasures, or additional security authentication with supply security devices), or updates to compatibility settings that govern which supplies may be installed in the imaging device.

Methods for accomplishing these changes outside of user-implemented firmware updates often use timer-based mechanisms, wherein the electronic device contains a clock that records the total elapsed uptime since a reference date/time. The electronic system's firmware monitors this clock value and deploys functions at certain times, typically based on a table of stored trigger values. However, a key disadvantage is that the timer can become significantly different from the true time. This may occur due to tampering in which the timer is rolled backward or slowed down in order to disable previously enabled functions altogether, or where the timer is sped up to allow discovery of future function deployment.

In order to ensure the use of authentic components in an electronic device, it is desirable to be able to detect tampering of the timer. Accordingly, there is a need for improved systems and methods for detecting tampering of timers in electronic devices.

### SUMMARY

The present disclosure provides example methods and systems that may be implemented in any general electronic system or specifically in an imaging/printing device/system to thwart the use of non-authentic components and/or thwart the manipulation of imaging device security procedures by tampering with the clock.

There is provided a method of detecting clock tampering in an imaging device, the method comprising: reading a host start time from a host firmware clock of the imaging device, reading a security start time from a security device clock installed in the imaging device, and reading a host end time from the host firmware clock, reading a security end time from the security device clock, comparing a host interval time between the host start time and the host end time with a security interval time between the security start time and the security end time, and when a difference between the host interval time and the security interval time is greater than a threshold, determining that the host firmware clock has been tampered with.

In this way, two measurements of a period of time by the security device clock and the host firmware clock are compared and if the difference between them is greater than a threshold, then it is deemed that the host firmware clock has been tampered with. In certain implementations, the host start time and the security start time correspond to the start of an action, such as a communication, wait period, algorithm or other action to be completed on the host firmware, security device or another component. In certain implementations, the host end time and the security end time correspond to the end of the action. In certain implementations, when it is determined that the host firmware clock has been tampered with, normal operation of the imaging device is prevented. This means that when a clock has been tampered with, the imaging device will not continue operating.

The host firmware start time corresponds to the security start time in the same manner as the host end time corresponds to the security end time. For example, the host start time may be read, then a command sent to the security device to read the security start time. Then, when the host end time is read, a command is sent to the security device to read the security end time. In this way the host interval and the security interval should be the same when the security and the host clocks are running at the same speed. So, when a difference greater than a threshold is detected, tampering of the host clock is determined.

In certain implementations, the method further comprises sending, by the host firmware a start command to the security device, the start command causing the security device to read the security start time from the security device clock. In certain implementations, the start command comprises the host start time.

In certain implementations, the security device sends a timestamp with a command and/or response. The sending of the timestamp may cause the host to read the host start time and the host end time and comparing the host interval time with the security interval time. The timestamp may be indicative of the security start time and another timestamp sent with a later command/response may be the security end time. The host firmware and/or security device may send a timestamp with a selection of, or every, command/response. This causes an ongoing check of the host clock which means that tampering may be detected quickly. The timestamp, when sent from the host firmware may be indicative of the host start time and another timestamp sent with a later command/response by the host firmware may be the host end time.

In certain implementations, when the host firmware is in control of the commands, the host may poll the security device, sending commands over a period of time, with each command including the current host firmware clock time. While the security device is waiting for the security interval time, the security device may respond with a busy response or not acknowledge the command (for I2C communication, for example). Once the security device has waited for the security interval time, it may accept the host time sent in the last command, calculate the host time interval and compare the security interval with the host interval. Other methods can be used like a general-purpose input/output (GPIO) to send an interrupt or notification to the host that the security device is done waiting (and so the security interval time has elapsed).

In certain implementations, the method further comprises sending, by the host firmware an end command to the security device, the end command causing the security device to read the security end time from the security device clock. In certain implementations, the end command comprises the host end time. The end command may cause the security device to calculate the host interval and the security interval and compare the intervals.

In certain implementations, the method further comprises determining the host interval time by subtracting the host start time from the host end time. Determining the host interval time by subtracting the host start time from the host end time may optionally be performed by the host firmware or the security device, or another component of the imaging device. In certain implementations, the method further comprises waiting, by the host firmware, for the host interval time after the host start time and then reading the host end time. In this way, the host interval does not need to be calculated.

In certain implementations, the method further comprises determining the security interval time by subtracting the security start time from the security end time. Determining the security interval time by subtracting the security start time from the security end time may optionally be performed by the host firmware or the security device, or another component of the imaging device. In certain implementations, the method further comprises waiting, by the security device, for the security interval time after the security start time and then reading the security end time. In this way, the security interval does not need to be calculated.

In certain implementations, a communication sequence is performed to read the host start time and security start time and said communication sequence is performed to read the host end time and security end time. For example, the communication sequence may comprise first reading the host start or end time, then immediately sending a command to the security device, then receiving the security start or end time. The common communication sequences for the start and end times ensure the host and security intervals are comparable.

In certain implementations, preventing normal operation of the imaging device comprises interrupting signals sent to a print component. A print component may be a print head, a monitor-enforce block or another component utilised in printing by the imaging device.

In certain implementations, the steps of comparing the host interval time with the security interval time and, when the difference between the host interval time and the security interval time is greater than the threshold, determining that the host firmware clock has been tampered with, are performed by the security device.

In certain implementations, the steps of comparing the host interval time with the security interval time and, when the difference between the host interval time and the security interval time is greater than the threshold, determining that the host firmware clock has been tampered with, are performed by the host firmware. The threshold may be 25% of the host and/or security interval, or lower, for example, 10% or 5%. In certain implementations, the host interval is greater than 10 milliseconds.

In certain implementations, authentication information may be sent with times and/or commands. Verification of the authentication information may be performed before the host or security device reads the time provided in the communication.

There is provided an imaging device, comprising host firmware, the host firmware configured to: read a host start time from a host firmware clock of the imaging device, read a host end time from the host firmware clock, compare a host interval time between the host start time and the host end time with a security interval time between a security start time and a security end time read from a security device clock of a security device installed in the imaging device, and when a difference between the host interval time and the security interval time is greater than a threshold, determine that the host firmware clock has been tampered with.

In certain implementations, the host firmware is further configured to send a start command to the security device, the start command causing the security device to read the security start time from the security device clock.

In certain implementations, the host firmware is further configured to send an end command to the security device, the end command causing the security device to read the security end time from the security device clock. The imaging device may be configured to perform any combination of features of the method described above.

There is further provided a security device for an imaging device, the security device configured to: read a security start time from a security device clock of the imaging device, and read a security end time from the security device clock, compare a host interval time between a host start time and a host end time with a security interval time between the security start time and the security end time, and when a difference between the host interval time and the security interval time is greater than a threshold, determine that the host firmware clock has been tampered with. The security device may be configured to perform any combination of features of the method described above.

There is further provided a supply item for use with an imaging device in an imaging system, the supply item comprising the security device as described above. The supply item may be a toner cartridge, imaging unit or a fuser or another type of supply item.

There is further provided an imaging system comprising the supply item as described above installed in the imaging device as described above.

There is further provided a method of detecting clock tampering in an imaging device, the method comprising: reading a host start time from a host firmware clock of the imaging device, the host start time corresponding to a start of an action performed by a component of the imaging device, and reading a host end time from the host firmware clock, the host end time corresponding to an end of the action performed by the component of the imaging device, comparing a host interval time between the host start time and the host end time with a component interval time, corresponding to the time taken to perform the action by the component, and when a difference between the host interval time and the component interval time is greater than a threshold, determining that the host firmware clock has been tampered with.

In certain implementations, the component interval time is the security interval time as described in the method above. In certain implementations, the host start time is the time when a command is sent to the component of the imaging device, and the host end time is the time when a response to the command is received from the component, and the component interval time is an expected response time for the command. The component may be any component of the imaging device, for example a security device, a supply item, a print head, or any other component. The command may cause the component to perform an operation. The operation should have a consistent run time. In certain implementations, the operation is run during manufacturing and the time taken for the operation to run is determined. The determined run time may be saved as the expected response time in the imaging device, for example in firmware.

In certain implementations, the method further comprises determining the host interval time by subtracting the host start time from the host end time.

In certain implementations, host firmware of the imaging device sends the host start time and the host end time and/or the host interval to the component and the component performs the steps of: comparing the host interval time, with the component interval time, and when a difference between the host interval time and the component interval time is greater than the threshold: determining that the host firmware clock has been tampered with.

In certain implementations, the method further comprises: when it is determined that the host firmware clock has been tampered with, preventing normal operation of the imaging device. Preventing the normal operation of the imaging device may be performed by host firmware or by the component, or by a third component such as a security device.

In certain implementations, preventing normal operation of the imaging device comprises interrupting signals sent to a print component. For example, signals to a print head may be interrupted, for example by a monitor-enforce block.

In certain implementations, the steps of comparing the host interval time with the component interval time and, when the difference between the host interval time and the component interval time is greater than the threshold, determining that the host firmware clock has been tampered with, are performed by the host firmware. The threshold may be 25% of the host and/or security interval, or lower, for example, 10% or 5%. In certain implementations, the host interval is greater than 10 milliseconds.

In certain implementations, authentication information may be sent with times and/or commands. Verification of the authentication information may be performed before the host or security device reads the time provided in the communication.

In certain implementations, the component is a security device of the imaging device.

In certain implementations, when the host firmware of the imaging device receives the response, the host sends the host end time and/or the host interval to the component.

In certain implementations, the command comprises the host start time.

In certain implementations, the steps of comparing the host interval time with the component interval time and, when the difference between the host interval time and the component interval time is greater than the threshold, determining that the host firmware clock has been tampered with, are performed by the component.

There is further provided an imaging device, comprising host firmware, the host firmware configured to: read a host start time from a host firmware clock of the imaging device, the host start time corresponding to a start of an action performed by a component of the imaging device, and read a host end time from the host firmware clock, the host end time corresponding to an end of the action performed by the component of the imaging device, compare a host interval time between the host start time and the host end time with a component interval time, corresponding to the time taken to perform the action by the component, and when a difference between the host interval time and the component interval time is greater than a threshold, determining that the host firmware clock has been tampered with. In certain implementations, the component interval time is the security interval time as described in the method above. In certain implementations, the host start time is the time when a command is sent to the component of the imaging device, and the host end time is the time when a response to the command is received from the component, and the component interval time is an expected response time for the command. The imaging device may be configured to perform any combination of the features of the method described above.

There is further provided a component for an imaging device, the component configured to: receive a host start time and a host end time and calculate a host interval time between the host start time and the host end time, or receive the host interval time, compare the host interval time, with a component interval time corresponding to the time taken to perform an action by the component, and when a difference between the host interval time and the component interval time is greater than the threshold determine that the host firmware clock has been tampered with.

In certain implementations, the component is configured to: perform the action for the component interval time, and communicate the end of the action to host firmware of the imaging device. In certain implementations, the component suspends communication with the host firmware for the component interval time. In certain implementations, the action is an operation with a consistent execution time. In certain implementations, the component is a security device. The component may be configured to perform any combination of the features of the method described above.

There is further provided a supply item for use with an imaging device in an imaging system, the supply item comprising the component described above. The supply item may be a toner cartridge, imaging unit or a fuser or another type of supply item.

There is further provided an imaging system comprising the supply item as described above installed in the imaging device as described above.

There is further provided a method of detecting clock tampering in an electronic device, the method comprising: reading a host start time from a host firmware clock of the electronic device, reading a security start time from a security device clock installed in the electronic device, and reading a host end time from the host firmware clock, reading a security end time from the security device clock, comparing a host interval time between the host start time and the host end time with a security interval time between the security start time and the security end time, and when a difference between the host interval time and the security interval time is greater than a threshold, determining that the host firmware clock has been tampered with.

In this way, two measurements of a period of time by the security device clock and the host firmware clock are compared and if the difference between them is greater than a threshold, then it is deemed that the host firmware clock has been tampered with. In certain implementations, the host start time and the security start time correspond to the start of an action, such as a communication, wait period, algorithm or other action to be completed on the host firmware, security device or another component. In certain implementations, the host end time and the security end time correspond to the end of the action. In certain implementations, when it is determined that the host firmware clock has been tampered with, normal operation of the electronic device is prevented. This means that when a clock has been tampered with, the electronic device will not continue operating.

The host firmware start time corresponds to the security start time in the same manner as the host end time corresponds to the security end time. For example, the host start time may be read, then a command sent to the security device to read the security start time. Then, when the host end time is read, a command is sent to the security device to read the security end time. In this way the host interval and the security interval should be the same when the security and the host clocks are running at the same speed. So, when a difference greater than a threshold is detected, tampering of the host clock is determined.

In certain implementations, the method further comprises sending, by the host firmware a start command to the security device, the start command causing the security device to read the security start time from the security device clock. In certain implementations, the start command comprises the host start time.

In certain implementations, the security device sends a timestamp with a command and/or response. The sending of the timestamp may cause the host to read the host start time and the host end time and comparing the host interval time with the security interval time. The timestamp may be indicative of the security start time and another timestamp sent with a later command/response may be the security end time. The host firmware and/or security device may send a timestamp with a selection of, or every, command/response. This causes an ongoing check of the host clock which means that tampering may be detected quickly. The timestamp, when sent from the host firmware may be indicative of the host start time and another timestamp sent with a later command/response by the host firmware may be the host end time.

In certain implementations, when the host firmware is in control of the commands, the host may poll the security device, sending commands over a period of time, with each command including the current host firmware clock time. While the security device is waiting for the security interval time, the security device may respond with a busy response or not acknowledge the command (for I2C communication, for example). Once the security device has waited for the security interval time, it may accept the host time sent in the last command, calculate the host time interval and compare the security interval with the host interval. Other methods can be used like a general-purpose input/output (GPIO) to send an interrupt or notification to the host that the security device is done waiting (and so the security interval time has elapsed).

In certain implementations, the method further comprises sending, by the host firmware an end command to the security device, the end command causing the security device to read the security end time from the security device clock. In certain implementations, the end command comprises the host end time. The end command may cause the security device to calculate the host interval and the security interval and compare the intervals.

In certain implementations, the method further comprises determining the host interval time by subtracting the host start time from the host end time. Determining the host interval time by subtracting the host start time from the host end time may optionally be performed by the host firmware or the security device, or another component of the electronic device. In certain implementations, the method further comprises waiting, by the host firmware, for the host interval time after the host start time and then reading the host end time. In this way, the host interval does not need to be calculated.

In certain implementations, the method further comprises determining the security interval time by subtracting the security start time from the security end time. Determining the security interval time by subtracting the security start time from the security end time may optionally be performed by the host firmware or the security device, or another component of the electronic device. In certain implementations, the method further comprises waiting, by the security device, for the security interval time after the security start time and then reading the security end time. In this way, the security interval does not need to be calculated.

In certain implementations, a communication sequence is performed to read the host start time and security start time and said communication sequence is performed to read the host end time and security end time. For example, the communication sequence may comprise first reading the host start or end time, then immediately sending a command to the security device, then receiving the security start or end time. The common communication sequences for the start and end times ensure the host and security intervals are comparable.

In certain implementations, preventing normal operation of the electronic device comprises interrupting signals sent to a component. A component may be any component utilised in a primary function of the electronic device.

In certain implementations, the steps of comparing the host interval time with the security interval time and, when the difference between the host interval time and the security interval time is greater than the threshold, determining that the host firmware clock has been tampered with, are performed by the security device.

In certain implementations, the steps of comparing the host interval time with the security interval time and, when the difference between the host interval time and the security interval time is greater than the threshold, determining that the host firmware clock has been tampered with, are performed by the host firmware. The threshold may be 25% of the host and/or security interval, or lower, for example, 10% or 5%. In certain implementations, the host interval is greater than 10 milliseconds.

In certain implementations, authentication information may be sent with times and/or commands. Verification of the authentication information may be performed before the host or security device reads the time provided in the communication.

There is provided an electronic device, comprising host firmware, the host firmware configured to: read a host start time from a host firmware clock of the electronic device, read a host end time from the host firmware clock, compare a host interval time between the host start time and the host end time with a security interval time between a security start time and a security end time read from a security device clock of a security device installed in the electronic device, and when a difference between the host interval time and the security interval time is greater than a threshold, determine that the host firmware clock has been tampered with.

In certain implementations, the host firmware is further configured to send a start command to the security device, the start command causing the security device to read the security start time from the security device clock.

In certain implementations, the host firmware is further configured to send an end command to the security device, the end command causing the security device to read the security end time from the security device clock. The electronic device may be configured to perform any combination of features of the method described above.

There is further provided a security device for an electronic device, the security device configured to: read a security start time from a security device clock of the electronic device, and read a security end time from the security device clock, compare a host interval time between a host start time and a host end time with a security interval time between the security start time and the security end time, and when a difference between the host interval time and the security interval time is greater than a threshold, determine that the host firmware clock has been tampered with. The security device may be configured to perform any combination of features of the method described above.

There is further provided a supply item for use with an electronic device in an electronic system, the supply item comprising the security device as described above. The supply item may be a toner cartridge, electronic unit or a fuser or another type of supply item.

There is further provided an electronic system comprising the supply item as described above installed in the electronic device as described above.

There is further provided a method of detecting clock tampering in an electronic device, the method comprising: reading a host start time from a host firmware clock of the electronic device, the host start time corresponding to a start of an action performed by a component of the electronic device, and reading a host end time from the host firmware clock, the host end time corresponding to an end of the action performed by the component of the electronic device, comparing a host interval time between the host start time and the host end time with a component interval time, corresponding to the time taken to perform the action by the component, and when a difference between the host interval time and the component interval time is greater than a threshold, determining that the host firmware clock has been tampered with.

In certain implementations, the component interval time is the security interval time as described in the method above. In certain implementations, the host start time is the time when a command is sent to the component of the electronic device, and the host end time is the time when a response to the command is received from the component, and the component interval time is an expected response time for the command. The component may be any component of the electronic device, for example a security device, a supply item, or any other component. The command may cause the component to perform an operation. The operation should have a consistent run time. In certain implementations, the operation is run during manufacturing and the time taken for the operation to run is determined. The determined run time may be saved as the expected response time in the electronic device, for example in firmware.

In certain implementations, the method further comprises determining the host interval time by subtracting the host start time from the host end time.

In certain implementations, host firmware of the electronic device sends the host start time and the host end time and/or the host interval to the component and the component performs the steps of: comparing the host interval time, with the component interval time, and when a difference between the host interval time and the component interval time is greater than the threshold: determining that the host firmware clock has been tampered with.

In certain implementations, the method further comprises: when it is determined that the host firmware clock has been tampered with, preventing normal operation of the electronic device. Preventing the normal operation of the electronic device may be performed by host firmware or by the component, or by a third component such as a security device.

In certain implementations, preventing normal operation of the electronic device comprises interrupting signals sent to a component. For example, signals to a primary function component may be interrupted, for example by a monitor-enforce block.

In certain implementations, the steps of comparing the host interval time with the component interval time and, when the difference between the host interval time and the component interval time is greater than the threshold, determining that the host firmware clock has been tampered with, are performed by the host firmware. The threshold may be 25% of the host and/or security interval, or lower, for example, 10% or 5%. In certain implementations, the host interval is greater than 10 milliseconds.

In certain implementations, authentication information may be sent with times and/or commands. Verification of the authentication information may be performed before the host or security device reads the time provided in the communication.

In certain implementations, the component is a security device of the electronic device.

In certain implementations, when the host firmware of the electronic device receives the response, the host sends the host end time and/or the host interval to the component.

In certain implementations, the command comprises the host start time.

In certain implementations, the steps of comparing the host interval time with the component interval time and, when the difference between the host interval time and the component interval time is greater than the threshold, determining that the host firmware clock has been tampered with, are performed by the component.

There is further provided an electronic device, comprising host firmware, the host firmware configured to: read a host start time from a host firmware clock of the electronic device, the host start time corresponding to a start of an action performed by a component of the electronic device, and read a host end time from the host firmware clock, the host end time corresponding to an end of the action performed by the component of the electronic device, compare a host interval time between the host start time and the host end time with a component interval time, corresponding to the time taken to perform the action by the component, and when a difference between the host interval time and the component interval time is greater than a threshold, determining that the host firmware clock has been tampered with. In certain implementations, the component interval time is the security interval time as described in the method above. In certain implementations, the host start time is the time when a command is sent to the component of the electronic device, and the host end time is the time when a response to the command is received from the component, and the component interval time is an expected response time for the command. The electronic device may be configured to perform any combination of the features of the method described above.

There is further provided a component for an electronic device, the component configured to: receive a host start time and a host end time and calculate a host interval time between the host start time and the host end time, or receive the host interval time, compare the host interval time, with a component interval time corresponding to the time taken to perform an action by the component, and when a difference between the host interval time and the component interval time is greater than the threshold determine that the host firmware clock has been tampered with.

In certain implementations, the component is configured to: perform the action for the component interval time, and communicate the end of the action to host firmware of the electronic device. In certain implementations, the component suspends communication with the host firmware for the component interval time. In certain implementations, the action is an operation with a consistent execution time. In certain implementations, the component is a security device. The component may be configured to perform any combination of the features of the method described above.

There is further provided a supply item for use with an electronic device in an electronic system, the supply item comprising the component described above. The supply item may be a toner cartridge, electronic unit or a fuser or another type of supply item.

There is further provided an electronic system comprising the supply item as described above installed in the electronic device as described above.

In any of the implementations/embodiments described herein, the components may be connected via any shared bus, such as I2C or peer-to-peer.

The methods, devices, supply items and systems described above may be employed in any combination. The optional features described above are equally applicable to all of the described methods, devices, supply items and systems and are not limited to the particular method/device/supply item/system with which they are described. The essential features of any of the methods, devices, supply items and systems described may be optional features of any other methods, devices, supply items and systems described.

From the foregoing disclosure and the following detailed description of various examples, it will be apparent to those skilled in the art that the present disclosure provides a significant advance in the art of determining the authenticity of a component in an electronic system. Additional features and advantages of various examples will be better understood in view of the detailed description provided below.

As used herein, the term ‘leader’ is equivalent to the term ‘master’ and can be used interchangeably throughout without changing the meaning. As used herein, the term ‘follower’ is equivalent to the term ‘slave’ and can be used interchangeably throughout without changing the meaning. Both terms ‘master’ and ‘slave’ take their usual meanings in the art, for example, as used in the official I2C specification.

### BRIEF DESCRIPTION OF THE DRAWINGS

The above-mentioned and other features and advantages of the present disclosure, and the manner of attaining them, will become more apparent and will be better understood by reference to the following description of examples taken in conjunction with the accompanying drawings. Like reference numerals are used to indicate the same element throughout the specification.

FIG. 1 is a diagrammatic view of an imaging system.

FIG. 2 is a flow chart showing a method of detecting tampering of a clock in an imaging device.

FIG. 3 is flow chart showing a method of detecting tampering of a clock in an imaging device.

FIG. 4 is a timeline showing time readings taken in the methods shown in FIGS. 2 and 3.

FIG. 5 is a flow chart showing a method of detecting tampering of a clock in an imaging device.

### DETAILED DESCRIPTION OF THE DRAWINGS

It is to be understood that the disclosure is not limited to the details of construction and the arrangement of components set forth in the following description or illustrated in the drawings. The disclosure is capable of other examples and of being practiced or of being carried out in various ways. For example, other examples may incorporate structural, chronological, process, and other changes. Examples merely typify possible variations. Individual components and functions are optional unless explicitly required, and the sequence of operations may vary. Portions and features of some examples may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

It will be further understood that each block of the flow charts, and combinations of blocks in the flow charts, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the flow charts discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the flow charts support combinations of means for performing the specified functions, combinations of steps for performing the specified functions and program instruction means for performing the specified functions. It will also be understood that each block of the flow charts, and combinations of blocks in the flow charts, can be implemented by special purpose hardware-based computer systems that perform the specified functions or steps or combinations of special purpose hardware and computer instructions.

Disclosed are example systems and methods for detecting clock tampering in an electronic system, such as an imaging/printer system.

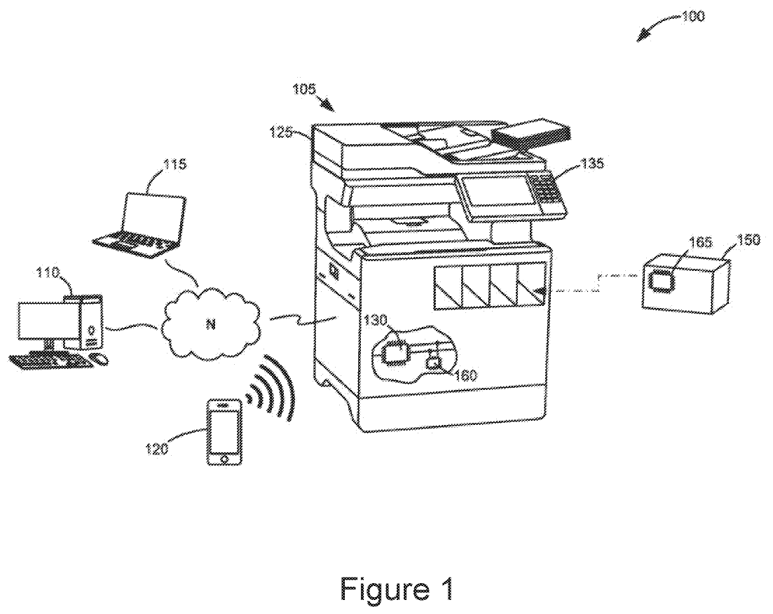

Referring to FIG. 1, there is shown a diagrammatic view of an imaging system 100 used in association with the present disclosure. Imaging system 100 includes an imaging device 105 used for printing images on sheets of media. Image data of the image to be printed on a media sheet may be supplied to imaging device 105 from a variety of sources such as a computer 110, laptop 115, mobile device 120, scanner 125 of the imaging device 105, or like computing device. The sources directly or indirectly communicate with imaging device 105 via wired and/or wireless connections.

Imaging device 105 includes an imaging device component 130 and a user interface 135. Imaging device component 130 may include a processor and associated memory. In some examples, imaging device component 130 may be formed as one or more Application Specific Integrated Circuits (ASICs) or System-on-Chip (SoCs). Memory may be any memory device which stores data and may be used with or capable of communicating with processor. For example, memory may be any volatile or non-volatile memory or combination thereof such as, for example, random access memory (RAM), read-only memory (ROM), flash memory and/or non-volatile RAM (NVRAM) for storing data. Optionally, imaging device component 130 may control the processing of print data. Optionally, imaging device component 130 may also control the operation of a print engine during printing of an image onto a sheet of media.

In one example, imaging device 105 may employ an electronic authentication scheme to authenticate consumable supply items and/or replaceable units installed in imaging device 105. In FIG. 1, a representative consumable supply item/replaceable item, such as a toner cartridge 150, is shown (other consumable/replaceable supply items can equally be used in addition or instead, such as imaging units and fusers). Supply item 150 may be installed in a corresponding storage area in imaging device 105. To perform authentication of supply item 150, imaging device 105 may utilize an imaging device security device 160 incorporated in imaging device 105 and a supply item security device 165 of supply item 150.

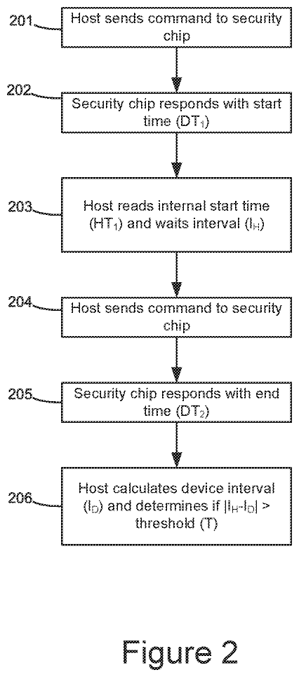

A method of detecting clock tampering on the imaging device 105 will now be described with reference to FIG. 2.

At block 201, the host firmware of the imaging device sends a command to the security device. The command causes the security device to read the security device start time DT₁ from the security device clock and respond by sending the security device start time DT₁ to the host firmware at block 202. At block 203, on receipt of the security device start time DT₁, the host reads its internal start time from the host firmware clock, the host start time HT₁, and waits for the host interval I_{H}.

After the host interval I_{H}, at block 204, the host firmware sends a command to the security device. The command causes the security device to read the security device end time DT₂ from the security device clock and respond by sending the security device end time DT₂ to the host firmware at block 205.

On receipt of the security device end time DT₂, the host firmware calculates the security device interval I_{D} and determines if an absolute difference between the security device interval and the host interval is greater than a threshold T at block 206. When the difference between the host interval time and the security interval time is greater than a threshold, it is determined that the host firmware clock has been tampered with and normal operation of the imaging device is prevented.

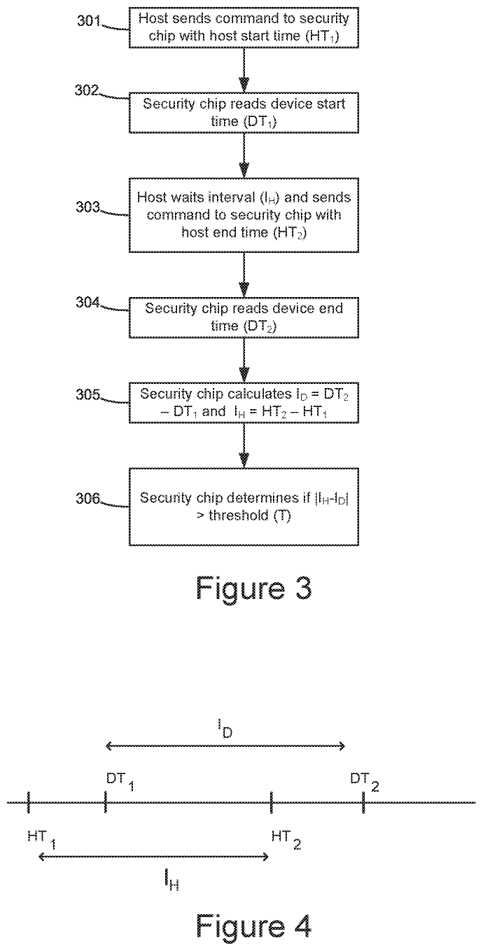

In an alternative method illustrated in FIG. 3, the host firmware sends a command to the security device at block 301, the command including the host start time HT₁. On receipt of the command, the security device reads the security device start time DT₁from the security device clock at block 302. The host firmware then waits at block 303 for the host interval I_{H} before sending another command to the security device, the command including the host end time HT₂. At block 304, the security device reads the security end time DT₂ from the security device clock. The security device then calculates the security interval I_{D} and the host interval I_{H} at block 305. At block 306, the security device determines if an absolute difference between the security device interval and the host interval is greater than a threshold T. When the difference between the host interval time and the security interval time is greater than a threshold, it is determined that the host firmware clock has been tampered with and normal operation of the imaging device is prevented.

FIG. 4 shows a timeline of the host start and end times HT₁, HT₂, host interval, I_{H}, security start and end times, DT₁, DT₂ and security interval, I_{D}. By ensuring the communication pattern which links the host start time and security start time is the same as the communication pattern that links the host end time and the security end time, the intervals I_{H} and I_{D} represent the same real time. As such, any difference in the measured intervals allows the determination of clock tampering. Alternatively, when the communication time is insignificant in relation to the interval time, a tolerance can be added to the threshold to account for differences in communication patterns.

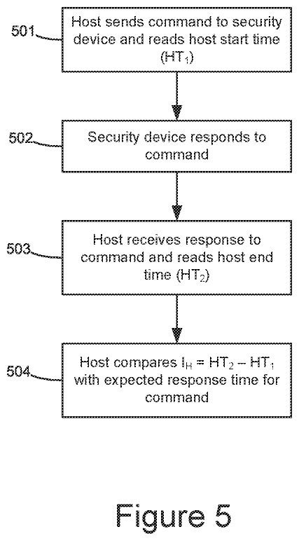

An alternative method of determining clock tampering is shown in FIG. 5. At block 501, the host firmware sends a command to a component of the imaging device, such as the security device. Other components with or without their own clocks may be utilised in this method. The host firmware also reads the host start time HT₁. The command includes instructions to perform an operation which has a consistent run time.

At block 502, the component responds to the command after completing the operation. At block 503, on receipt of the response, the host firmware reads the host end time HT₂. The host firmware then calculates the host interval I_{H} and compares the host interval with a stored expected response time for the command at block 504. When the absolute difference between the host interval time and the expected response time is greater than a threshold, it is determined that the host firmware clock has been tampered with and normal operation of the imaging device is prevented.

In alternative versions of the above methods, the security device and/or component may calculate the host interval time and determine the tampering of the clock.

In the above implementations/embodiments, the various components are configured as leader/follower components. This is purely optional and other communication busses may be used.

It will be understood that the example applications described herein are illustrative and should not be considered limiting. It will be appreciated that the actions described and shown in the example flow charts may be carried out or performed in any suitable order. It will also be appreciated that not all of the actions described in FIG. 2 or FIG. 3 need to be performed in accordance with the example embodiments of the disclosure and/or additional actions may be performed in accordance with other example embodiments of the disclosure.

Many modifications and other embodiments of the disclosure set forth herein will come to mind to one skilled in the art to which these disclosures pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Further disclosure is provided below.

Statement 1: A method of detecting clock tampering in an imaging device, the method comprising: reading a host start time from a host firmware clock of the imaging device, reading a security start time from a security device clock installed in the imaging device, and reading a host end time from the host firmware clock, reading a security end time from the security device clock, comparing a host interval time between the host start time and the host end time with a security interval time between the security start time and the security end time, and when a difference between the host interval time and the security interval time is greater than a threshold, determining that the host firmware clock has been tampered with.

Statement 2: The method of statement 1, the method further comprising waiting, by the host firmware, for the host interval time after the host start time and then reading the host end time.

Statement 3: The method of statement 1, the method further comprising determining the security interval time by subtracting the security start time from the security end time.

Statement 4: The method of statement 1, the method further comprising sending, by the host firmware a start command to the security device, the start command causing the security device to read the security start time from the security device clock.

Statement 5: The method of statement 4, wherein the start command comprises the host start time.

Statement 6: The method of statement 1, the method further comprising sending, by the host firmware an end command to the security device, the end command causing the security device to read the security end time from the security device clock.

Statement 7: The method of statement 6, wherein the end command comprises the host end time.

Statement 8: The method of statement 1, the method further comprising waiting, by the security device, for the security interval time after the security start time and then reading the security end time.

Statement 9: The method of statement 1, the method further comprising determining the host interval time by subtracting the host start time from the host end time.

Statement 10: The method of statement 1, wherein a communication sequence is performed to read the host start time and security start time and said communication sequence is performed to read the host end time and security end time.

Statement 11: The method of statement 1, the method further comprising: when it is determined that the host firmware clock has been tampered with, preventing normal operation of the imaging device.

Statement 12: The method of statement 11, wherein preventing normal operation of the imaging device comprises interrupting signals sent to a print component.

Statement 13: The method of statement 1, wherein the steps of comparing the host interval time with the security interval time and, when the difference between the host interval time and the security interval time is greater than the threshold, determining that the host firmware clock has been tampered with, are performed by the security device.

Statement 14: The method of statement 1, wherein the steps of comparing the host interval time with the security interval time and, when the difference between the host interval time and the security interval time is greater than the threshold, determining that the host firmware clock has been tampered with, are performed by the host firmware.

Statement 15: An imaging device, comprising host firmware, the host firmware configured to: read a host start time from a host firmware clock of the imaging device, read a host end time from the host firmware clock, compare a host interval time between the host start time and the host end time with a security interval time between a security start time and a security end time read from a security device clock of a security device installed in the imaging device, and when a difference between the host interval time and the security interval time is greater than a threshold, determine that the host firmware clock has been tampered with.

Statement 16: The imaging device of statement 15, the host firmware further configured to send a start command to the security device, the start command causing the security device to read the security start time from the security device clock.

Statement 17: The imaging device of statement 15, the host firmware further configured to send an end command to the security device, the end command causing the security device to read the security end time from the security device clock.

Statement 18: A security device for an imaging device, the security device configured to: read a security start time from a security device clock of the imaging device, and read a security end time from the security device clock, compare a host interval time between a host start time and a host end time with a security interval time between the security start time and the security end time, and when a difference between the host interval time and the security interval time is greater than a threshold, determine that the host firmware clock has been tampered with.

Statement 19: A supply item for use with an imaging device in an imaging system, the supply item comprising the security device of statement 18.

Statement 20: An imaging system comprising the supply item of statement 19 installed in the imaging device of statement 15.

What is claimed is:

1. A method of detecting clock tampering in an imaging device, the method comprising:
reading a host start time from a host firmware clock of the imaging device, the host start time corresponding to a start of an action performed by a component of the imaging device, and
reading a host end time from the host firmware clock, the host end time corresponding to an end of the action performed by the component of the imaging device,
comparing a host interval time between the host start time and the host end time with a component interval time, corresponding to the time taken to perform the action by the component, and
when a difference between the host interval time and the component interval time is greater than a threshold, determining that the host firmware clock has been tampered with.

2. The method of claim 1, wherein the host start time is the time when a command is sent to the component of the imaging device, and the host end time is the time when a response to the command is received from the component, and the component interval time is an expected response time for the command.

3. The method of claim 1, the method further comprising determining the host interval time by subtracting the host start time from the host end time.

4. The method of claim 1, wherein host firmware of the imaging device sends the host start time and the host end time and/or the host interval to the component and the component performs the steps of:
comparing the host interval time, with the component interval time, and
when a difference between the host interval time and the component interval time is greater than the threshold:
determining that the host firmware clock has been tampered with.

5. The method of claim 1, the method further comprising: when it is determined that the host firmware clock has been tampered with, preventing normal operation of the imaging device.

6. The method of claim 5, wherein preventing normal operation of the imaging device comprises interrupting signals sent to a print component.

7. The method of claim 1, wherein the steps of comparing the host interval time with the component interval time and, when the difference between the host interval time and the component interval time is greater than the threshold, determining that the host firmware clock has been tampered with, are performed by the host firmware.

8. The method of claim 1, wherein the component is a security device of the imaging device.

9. The method of claim 1, wherein when the host firmware of the imaging device receives the response, the host sends the host end time and/or the host interval to the component.

10. The method of claim 9, wherein the command comprises the host start time.

11. The method of claim 10, wherein the steps of comparing the host interval time with the component interval time and, when the difference between the host interval time and the component interval time is greater than the threshold, determining that the host firmware clock has been tampered with, are performed by the component.

13. An imaging device, comprising host firmware, the host firmware configured to:
read a host start time from a host firmware clock of the imaging device, the host start time corresponding to a start of an action performed by a component of the imaging device, and
read a host end time from the host firmware clock, the host end time corresponding to an end of the action performed by the component of the imaging device,
compare a host interval time between the host start time and the host end time with a component interval time, corresponding to the time taken to perform the action by the component, and
when a difference between the host interval time and the component interval time is greater than a threshold, determine that the host firmware clock has been tampered with.

14. A component for an imaging device, the component configured to:
receive a host start time and a host end time and calculate a host interval time between the host start time and the host end time, or receive the host interval time,
compare the host interval time, with a component interval time corresponding to the time taken to perform an action by the component, and
when a difference between the host interval time and the component interval time is greater than the threshold determine that the host firmware clock has been tampered with.

15. The component of claim 14, the component configured to:
perform the action for the component interval time, and
communicate the end of the action to host firmware of the imaging device.

16. The component of claim 15, wherein the component suspends communication with the host firmware for the component interval time.

17. The component of claim 15, wherein the action is an operation with a consistent execution time.

18. The component of claim 14, wherein the component is a security device.

19. A supply item for use with an imaging device in an imaging system, the supply item comprising the component of claim 14.

20. An imaging system comprising the supply item of claim 19 installed in the imaging device of claim 14.
